(19) United States
(12) Patent Application Publication
(10) Pub. No.: US 2024/0302477 A1
(43) Pub. Date: Sep. 12, 2024

(54) DIRECTION FINDING TECHNIQUE FOR AMPLITUDE-ONLY SPIRAL ANTENNAS

(71) Applicant: The Regents of the University of Colorado, a body corporate, Denver, CO (US)

(72) Inventors: Gaeron R. Friedrichs, Milford, PA (US); Mohamed Ali Elmansouri, Broomfield, CO (US); Dejan S. Filopovic, Lafayette, CO (US)

(21) Appl. No.: 18/601,142

(22) Filed: Mar. 11, 2024

Related U.S. Application Data
(60) Provisional application No. 63/451,487, filed on Mar. 10, 2023.

(51) Int. Cl. G01S 3/14; H01Q 9/27

(52) U.S. Cl. CPC G01S 3/143; H01Q 9/27

(57) ABSTRACT

A direction finding system includes a multi-arm spiral antenna configured to receive a signal, a processor, and a memory including instructions. When executed by the processor, the instructions cause an artificial intelligence (AI) algorithm to detect amplitudes of voltage of the signal received by the multi-arm spiral antenna, estimate, by the AI algorithm, an elevation angle of the signal based on a frequency and the amplitudes of voltages of the signal, estimate, by the AI algorithm, an azimuth angle based on the frequency, the elevation angle, and the amplitudes, determine, by the AI, a rotational offset based on the frequency and a rotational model, and calculate and output, by the AI algorithm, a direction of a source of the signal based on the rotational offset and the azimuth angle.

### CROSS-REFERENCE TO RELATED APPLICATIONS

This application claims the benefit of and priority to U.S. Provisional Patent Application Ser. No. 63/451,487 filed on Mar. 10, 2023, and entitled “DIRECTION FINDING TECHNIQUE FOR AMPLITUDE-ONLY SPIRAL ANTENNAS,” which is expressly incorporated herein by reference in its entirety.

### GOVERNMENT RIGHTS

This invention was made with government support under grant number N00014-21-1-2641, awarded by the Office of Naval Research, and grant number DGE1650115, awarded by the National Science Foundation. The government has certain rights in the invention.

### FIELD

This disclosure relates to systems and methods for performing direction finding, and more particularly for performing direction finding with spiral antennas.

### BACKGROUND

Spiral antennas have seen deployment for a wide variety of applications since the mid 1900's. Its wideband impedance match, circular polarization, and mode-formed, frequency independent patterns have solidified, for example, its efficacy for direction finding (DF), spectrum sensing/detection, polarimetry, communications, and in-band full duplex operation. In nearly every application, and particularly for DF, the spiral is deployed with beamforming technology, whether it be analog (conventional) or digital (contemporary).

Conventionally, single mode spirals, which has multiple spiral arms and are beamformed to only output a single mode, have been used for amplitude-only DF. However, a beamformer is typically required and only a partial azimuth angle could be obtained from two spiral antennas. More complicated and advanced DF methodologies have to use multi-mode spirals. In this case, relationships between the modes in both amplitude and phase are used to locate the angle of arrival of a signal. Even though these implementations are conceptually straightforward to understand, deployment with a particular receiver architecture is non-trivial.

Further, three main mixer/intermediate frequency (IF) configurations are necessary. Each topology consists of mode forming (generation of the sum and difference signals) as well as beamforming (linear combining of the modes). In the mixer/IF configurations, each channel of the antenna can be mixed down to some IF. Then, the sum and difference signals can be extracted through IF mode forming, and further processed via IF beamforming. The ability to do both mode forming and beamforming at IF is offset by well-balanced mixers to cover large bandwidths.

Overall, four mixers and four IF amplifiers are required for this approach. Alternatively, mode forming can be performed at RF. This popular approach requires only two mixers and two IF amplifiers. The sum and difference signals are then brought down to IF to be beamformed. In this approach, all steps could be performed at RF. This predicates the use of a phase compensation network between the mode forming at RF and beamforming at RF. While no mixers or IF amplifiers are needed, four RF amplifiers are needed, and the approach is restricted to about 3:1 bandwidth.

### BRIEF SUMMARY

Disclosed embodiments include systems and methods for evaluating the quality of visual representations. The quality of visual representations are evaluated based on how accessible (e.g., color-blind safe), readable (e.g., good contrast), and explainable (e.g., contain captions and legends) documents are.

This summary is provided to introduce a selection of concepts in a simplified form that are further described below in the Detailed Description. Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

In accordance with various aspects of the present disclosure, a direction finding system includes a multi-arm spiral antenna configured to receive a signal, a processor, and a memory including instructions. When executed by the processor, the instructions cause an artificial intelligence (AI) algorithm to detect amplitudes of voltage of the signal received by the multi-arm spiral antenna, estimate, by the AI algorithm, an elevation angle of the signal based on a frequency and the amplitudes of voltages of the signal, estimate, by the AI algorithm, an azimuth angle based on the frequency, the elevation angle, and the amplitudes, determine, by the AI, a rotational offset based on the frequency and a rotational model, and calculate and output, by the AI algorithm, a direction of a source of the signal based on the rotational offset and the azimuth angle.

In accordance with various aspects of the present disclosure, a method performs direction finding with a direction finding system including a multi-arm spiral antenna configured to receive a signal. The method includes detecting amplitudes of voltage of the signal received by the multi-arm spiral antenna, estimating, by an artificial intelligence (AI) algorithm, an elevation angle of the signal based on a frequency and the amplitudes of voltages of the signal, estimating, by the AI algorithm, an azimuth angle based on the frequency, the elevation angle, and the amplitudes, determining, by the AI algorithm, a rotational offset based on the frequency and a rotational model, and calculating and outputting, by the AI algorithm, a direction of a source of the signal based on the rotational offset and the azimuth angle.

In accordance with various aspects of the present disclosure, a non-transitory computer readable medium includes instructions that, when executed by a computer, cause an artificial algorithm (AI) to perform a method for performing direction finding with a direction finding system including a multi-arm spiral antenna configured to receive a signal. The method includes detecting amplitudes of voltage of the signal received by the multi-arm spiral antenna, estimating, by an artificial intelligence (AI) algorithm, an elevation angle of the signal based on a frequency and the amplitudes of voltages of the signal, estimating, by the AI algorithm, an azimuth angle based on the frequency, the elevation angle, and the amplitudes, determining, by the AI algorithm, a rotational offset based on the frequency and a rotational model, and calculating and outputting, by the AI algorithm, a direction of a source of the signal based on the rotational offset and the azimuth angle.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings described below.

FIG. 1 illustrates a direction finding system with a multi-arm spiral antenna in accordance with various aspects of the present disclosure;

FIG. 2 illustrates graphical representations of voltage standing wave ratios of the multi-arm spiral antenna of FIG. 1 in accordance with various aspects of the present disclosure;

FIG. 3 illustrates graphical representations of radiation patterns at a frequency in accordance with various aspects of the present disclosure;

FIG. 4 illustrates graphical representations of radiation patterns at a frequency in accordance with various aspects of the present disclosure;

FIG. 5 illustrates graphical representations of radiation patterns at a frequency in accordance with various aspects of the present disclosure;

FIG. 6 illustrates a block flow diagram for the direction finding system of FIG. 1 in accordance with various aspects of the present disclosure;

FIG. 7 illustrates graphical representations of elevation estimations at signal-to-noise ratios in accordance with various aspects of the present disclosure;

FIG. 8 illustrates graphical representations of radiation patterns before and after fixing a signal rotation in accordance with various aspects of the present disclosure;

FIG. 9 illustrates a confusion matrix for a subregion classifier using measured data in accordance with various aspects of the present disclosure;

FIG. 10 illustrates graphical representations of azimuthal subregion estimations at signal-to-noise ratios in accordance with various aspects of the present disclosure;

FIG. 11 illustrates a graphical representation of root-mean-square-errors of measured data in the UV-space in accordance with various aspects of the present disclosure;

FIG. 12 illustrates graphical representations of root-mean-square-errors of experiment data in the UV-space in accordance with various aspects of the present disclosure;

FIG. 13 illustrates output distributions and standard deviations of a signal in accordance with various aspects of the present disclosure;

FIG. 14 illustrates graphical representations of root-mean-square-error responses of a network trained across multiple polarizations in accordance with various aspects of the present disclosure;

FIG. 15 illustrates a flowchart for performing direction finding using a multi-arm spiral antenna in accordance with various aspects of the present disclosure; and

FIG. 16 illustrates a block diagram of a computing device in accordance with various aspects of the present disclosure.

### DETAILED DESCRIPTION

Disclosed systems and methods address known issues of bandwidth, loss, cost, and complexity limitations of analog amplitude-only spiral antenna direction finding systems. Disclosed aspects include a mode of operation for performing amplitude-only direction finding with the spiral antenna, in a way that it is more accessible (low cost, low integration complexity), and better performing (no beamforming loss, no bandwidth limitation imposed by beam/mode formers). In conventional systems, the bandwidth limitation is often the phase compensation network, and the loss is accrued in phase compensation network and the beam & mode forming networks. The multi-arm spiral may be used extensively in modern systems, as well as legacy systems. On the contrary, in the disclosed systems and methods, the beamformer, mode former, and phase compensation hardware are eliminated, thereby reducing all aspects in size, weight, power, and cost (SWAP-C) when compared to conventional methodologies.

For example, a mode forming network generates 4 modes. In a 4-arm spiral antenna, only 3 of them are useful but in practice, only 2 of them are used. To perform the mode forming, a 90° hybrid is used, and connected to two 180° hybrids. A 90° hybrid can take on loss (whose theoretical minimum is 3.01 dB) of 3.5-5.0 dB.

The 180° hybrids are arranged in a parallel-like configuration, and incur additional loss, about 3.8-4.5 dB. This gives approximately 7.3-9.5 dB of loss incurred by the mode forming network on its own. The beamforming network can be thought of as basically another 180° hybrid, yielding 11.1-14 dB of loss. To simplify the math, 10 dB of loss is assumed and that means the signal strength gets a 0.1× multiplier.

In a case where this loss on distance is modelled using Friis Transmission formula, Power received is equal to power transmitted*gain transmit*gain receive*wavelength/2*(1/(4*pi*d))². Assume everything except the distance “d” and power received “Pr” will change so:

$$Pr 1 = \frac{1}{d {1}^{2}} , and \qquad ( 1 )$$

$$0.1 * Pr 1 = {( \frac{1}{a * d 1} )}^{2} . \qquad ( 2 )$$

With the equations (1) and (2), “a” as a range multiplier may be calculated to be about 3. In other words, the range may be increased three times, and when using 14 dB of loss, the range may be increased 5 times.

With Friis in dB units, 10 dBm transmit power, 5 dB of gain, and 2 dB of receive gain, at a range of 1000 meters, power received may be calculated by the following:

$$\begin{matrix}Pr = Pt + Gt + Gr + 20 * {log}_{10} ( \frac{wavelength}{4 π d} ) \\ = 10 dBm + 5 dB + 2 dB + 20 * {log}_{10} ( \frac{0.01}{4 π * 1000} ) = \approx \\ - 105 dBm\end{matrix} . \qquad Friis formula$$

Since the disclosed system does not need a receive, there is no receive gain loss of dB. Thus, with the three times the range (i.e., 3000 meters), power received may be calculated to be about −105 dBm. Thus, the disclosed systems provides at least a 3-5 time improvement in detection range.

Disclosed systems and methods may simplify a direction finding (DF) problem for the main direction finding models based on the knowledge of frequency information. Azimuth and elevation estimations may be determined to enable multi-octave (ultrawideband) direction finding with the amplitude information.

Disclosed systems and methods may not require the use a radio frequency (RF) and intermediate frequency (IF) beamformer. Further, modelling the radiation pattern's rotation as a function of frequency may be employed with a compact neural network architecture to demonstrate multi-octave azimuth and elevation estimation with significant reduction in processing footprint. Furthermore, the multi-arm spiral antenna may be integrated to perform estimations with high accuracy over two or more octaves of bandwidth. Thus, disclosed systems and methods reduce the SWAP-C of conventional spiral antenna systems.

Further, as the disclosed systems and method leverages only amplitude information, no beamformer is required and no phase information is leveraged either in the beamforming or in the DF algorithm itself. The multi-arm spiral antenna may be a uniform circular array of elements whose position or coordinate reference frame rotate around an azimuth direction based on a frequency. In the case of a true frequency independent antenna, the same radiation pattern is observed over frequency when the reference frame rotates with the structure. Since the multi-arm spiral antenna may be a truncated version of a frequency independent antenna, the radiation patterns may be similar when compared to consecutive frequencies. This feature advance the ability to deploy a compact DF architecture for uniform circular arrays in conjunction with the frequency of operation to perform estimation in azimuth and elevation.

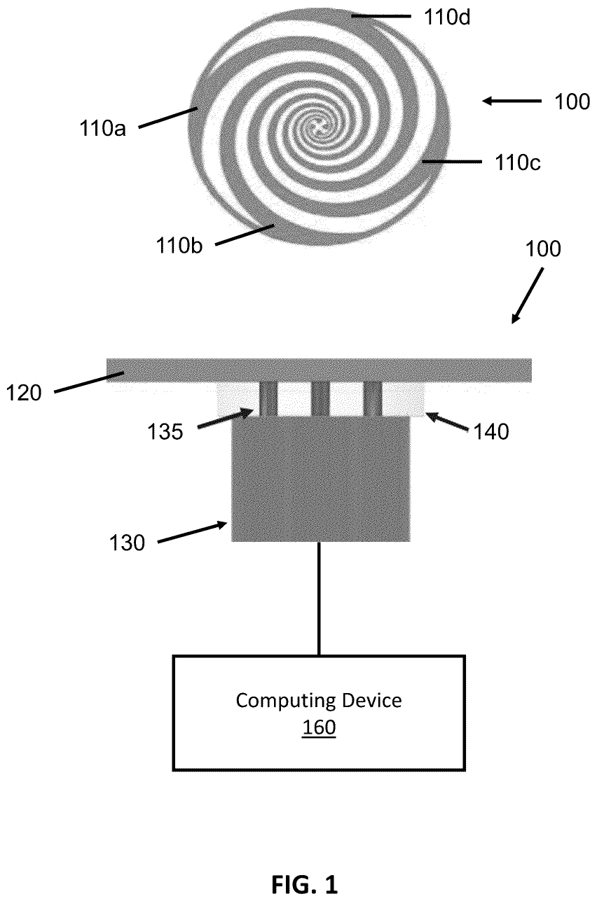

FIG. 1 illustrates a direction finding (DF) system 100, which finds a transmission source of a signal with a multi-arm spiral antenna in accordance with various aspects of the present disclosure. The DF system 100 includes a multi-arm spiral antenna 110 on a feed region 120. The multi-arm spiral antenna 110 may be printed or deposited on the feed region 120 via three-dimensional (3D) printing technology.

The multi-arm spiral antenna 110 may be Archimedean, log-periodic, or slot spiral antenna. The Archimedean spiral antenna configuration may be defined as:

$$r ( θ ) = a θ , \qquad ( 3 )$$

where “θ” is a polar angle in radian, “r” is a radius of each arm of the multi-arm spiral antenna 110, which increases linearly with the angle θ, and “a” is a constant that controls the rate at which the spiral or each arm flares out. The width of each arm may be substantially the same across the range of the angle θ.

The log-periodic spiral antenna may be defined as

$$r ( θ ) = {R}_{in} {e}^{a θ} , \qquad ( 4 )$$

where “r” is the radius of each spiral arm, “Rᵢₙ” is a constant that controls the initial radius of each spiral arm, “a” is a growth rate of each arm of the multi-arm spiral antenna 110, and “θ” is a polar angle in radian.

In an aspect, the growth rate “a” may be expressed as a function of the inner radius (Rᵢₙ), the outer radius (Rₒᵤₜ), and number of turns (N):

$$a = \frac{1}{2 π N} \times ln ( \frac{{R}_{out}}{{R}_{in}} ) . \qquad ( 5 )$$

To generate a single spiral arm, the curve expressed in equation (2) is parametrically generated twice, once with r(θ) and again with r(θ−π/4), for a metal to slot ratio (M/S) of 1. This ratio undertaking the value of unity may be the requirement for a self-complementary structure. These two curves may be then connected using an arc taken from a circle of radius Rₒᵤₜ, to form a closed structure. In a case where the multi-arm spiral antenna 110 has four arms, this single arm manufacturing may be repeated every π/2 radian four times. Considering the use of additive manufacturing for this structure, conversion to the slot spiral may allow to be partially self-supported.

In an aspect, the number of arms in the multi-arm spiral antenna 110 may be two, three, four, or more than four. In this case, the manufacturing a single arm may be repeated every 2π/N radian, where N is the number of arms.

The slot spiral antenna may be formed by subtracting a metal spiral from a larger radius circle, forming an outer ring that connects each arm of the spiral. This may allow for the spiral arm itself to be monolithically printed without additional assembly of the spiral arms of the multi-arm spiral antenna 110. The spiral itself may be extruded in the up direction or in the height direction. The thickness of the slot spiral antenna may be less or greater than or equal to 1.5 mm. Stercolithography (SLA) printer may be able to print the slot spiral antenna. This method helps control antenna match, by lowering the impedance of the multi-arm spiral antenna 110.

The DF system 100 may further include a coaxial bundle 130 and a spacer 140. The spacer 140 may provide a proper spacing between the feed region 120 and the coaxial bundle 130. The spacer 140 may be made of Teflon.

Each coaxial cable 130 may be coupled to a respective arm of the multi-arm spiral antenna 110. In this way, the signal detected or received by the multi-arm spiral antenna 110 may be transmitted to and through the coaxial cables 130. The number of coaxial cables 130 may be equal to the number of spiral arms of the multi-arm spiral antenna 110.

The signal received by the multi-arm spiral antenna 110 may be fed utilizing four 3 mm outer diameter coaxial cables 130 whose shields are soldered together in the coaxial bundle 130. The central conductor 135 of each coaxial cable 130 may be connected to each respective spiral arm. The outer conductor may be stripped 1.5 mm from the spiral arms of the multi-arm spiral antenna 110.

In an aspect, the spacer 140 and the coaxial bundle 130 may be surrounded or housed by an absorber. A cavity may be designed and filled within the absorber to reduce the rearward radiation of the DF system 100 and to mitigate the impact of the feed cables, as well as facilitating flush-mounting for platform installation. A cylindrical piece of the absorber may be placed inside the cavity, with an additional ring of the absorber extending to the spiral arms. This absorber ring may serve as a lossy arms termination, which improves the match at low frequencies and provides smoother radiation patterns.

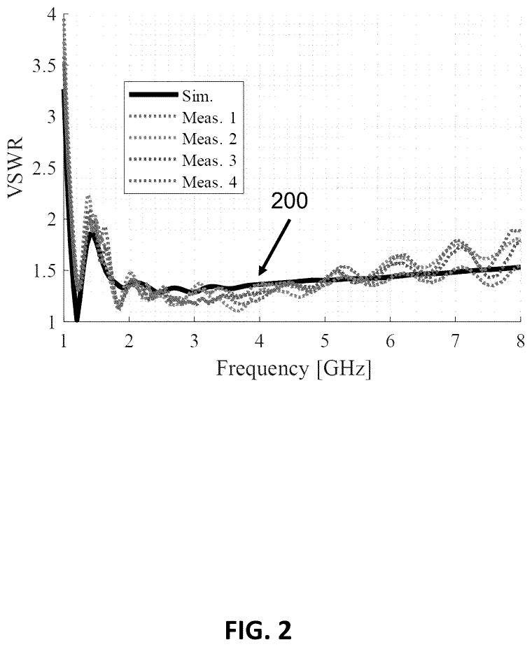

The DF system 100 with the 4-port spiral antenna 110 may be characterized via s-parameters and far field measurements. The DF system 100 may be designed to have a low voltage standing wave ratio (VSWR), which is lower than two over the band of interest as illustrated in FIG. 2. The horizontal axis represents a range of frequencies of the signal from 1 GHz to 8 GHZ, and the vertical axis represents VSWR errors. Solid curve 200 is based on simulation and dotted curves are based on measurements. As illustrated, the VSWR errors of the solid line curve 200 and the dotted line curves are mostly lower than two over most of the range of frequencies. That implies better impedance match is in the DF system 100 and more power is delivered to the multi-arm spiral antenna 110. In an aspect, the range of frequencies may be from 1.5 GHz to 6 GHz. In another aspect, the range of frequencies may be three octaves or more so that the range of frequencies is wider than the range from 1.5 GHz to 6 GHZ.

The DF system 100 may further include a computing device 160, which may process digital signals. The analog signal received by the multi-arm spiral antenna 110 and via the coaxial bundle 130 may be digitized via an analog-to-digital converter (ADC) into digital signals. The ADC may be a separate element disposed between the DF system 100 and the computing device 160 or may be incorporated into the computing device 160.

The computing device 160 may perform digital processing on the digital signal to find the direction of the transmission source of the signal. In an aspect, the computing device 160 may employ one or more artificial intelligence (AI) or machine learning (ML) algorithm (hereinafter collectively “AI” algorithm) in direction finding.

Training data may be used to train the AI algorithm. Such training data may be generated in an anechoic chamber with the DF system 100. The multi-arm spiral antenna 110 may be mounted on a high-precision spherical positioner inside of the anechoic chamber and the signal source may be mounted at a specific elevation angle and at a specific azimuth angle. The elevation angle may range from 0 to 180 degrees and the azimuth angle may range from 0 to 360 degrees.

The data detected by the multi-arm spiral antenna 110 may be saved with the specific elevation angle and the specific azimuth angle. Specifically, the data is made up with data from four channel or four spiral arm antenna of the multi-arm spiral antenna 110. In this case, the specific elevation and azimuth angles are considered as a tag for the data, as one piece of the training data. Further, at each frequency in the frequency range, the data may be collected and saved at each elevation angle and each azimuth angle.

In an aspect, the training data may be pre-processed to eliminate or reduce noises or influences of the DF system 100 and environment and/or post-processed to increase quality and effectiveness of antenna measurement data.

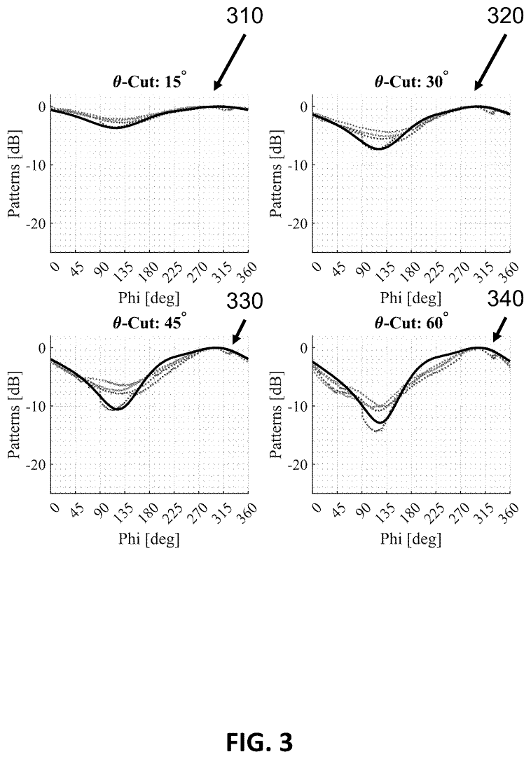

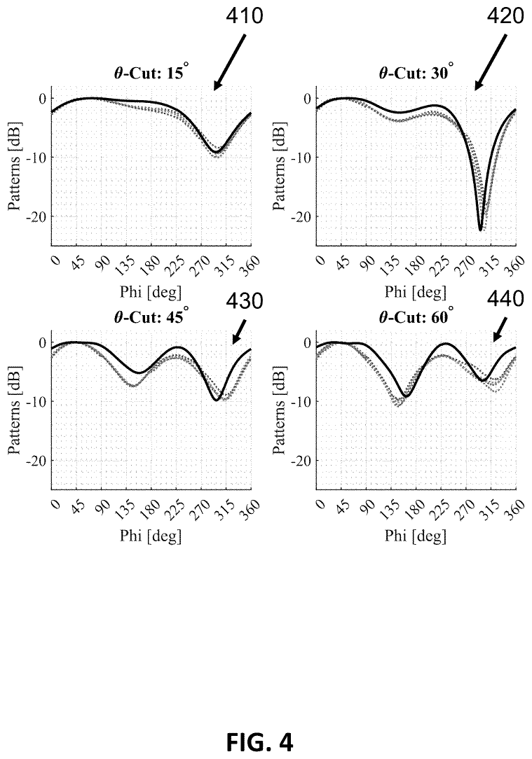

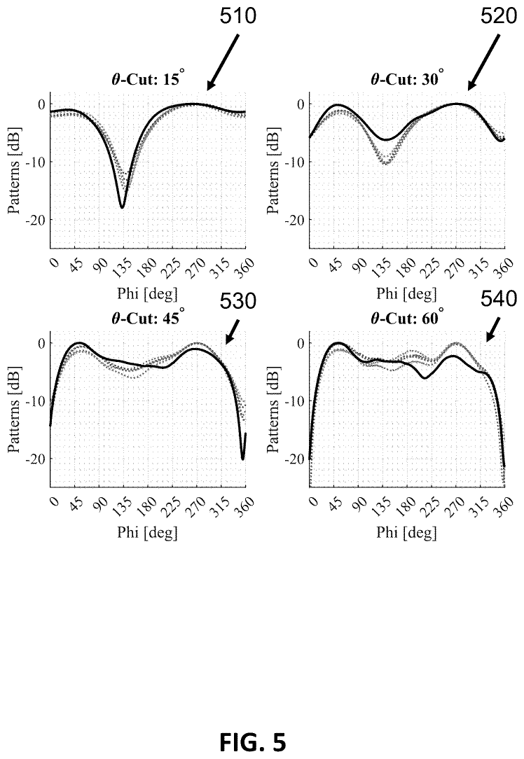

Radiation patterns in simulation and measurement are illustrated in FIGS. 3-5 with the multi-arm spiral antenna 110 of FIG. 1. In particular, radiation patterns at 1.5 GHZ, 3 GHz, and 6 GHz are illustrated in FIGS. 3-5, respectively. The horizontal axes represent the azimuth angles ranging from 0° to 360°, and the vertical axes represent amplitudes of the signal in dB scale at each constant elevation angle. Solid curves show simulated amplitude results and dotted curves show measured amplitude results.

The first curves 310, 410, and 510 of FIGS. 3-5 show the amplitude of the signal at 15° of the elevation angle, the second curves 320, 420, and 520 show the amplitude of the signal at 30° of the elevation angle, the third curves 330, 430, and 530 show the amplitude of the signal at 30° of the elevation angle, and the fourth curves 340, 440, and 540 show the amplitude of the signal at 60° of the elevation angle. Based on the curves at one elevation angle (e.g., 15°, 30°, 45°, or 60°) of FIGS. 3-5, the amplitude patterns over the frequency ranges rotates based on the frequency. Thus, the amplitude only may be used to determine the direction of the transmission source of the signal.

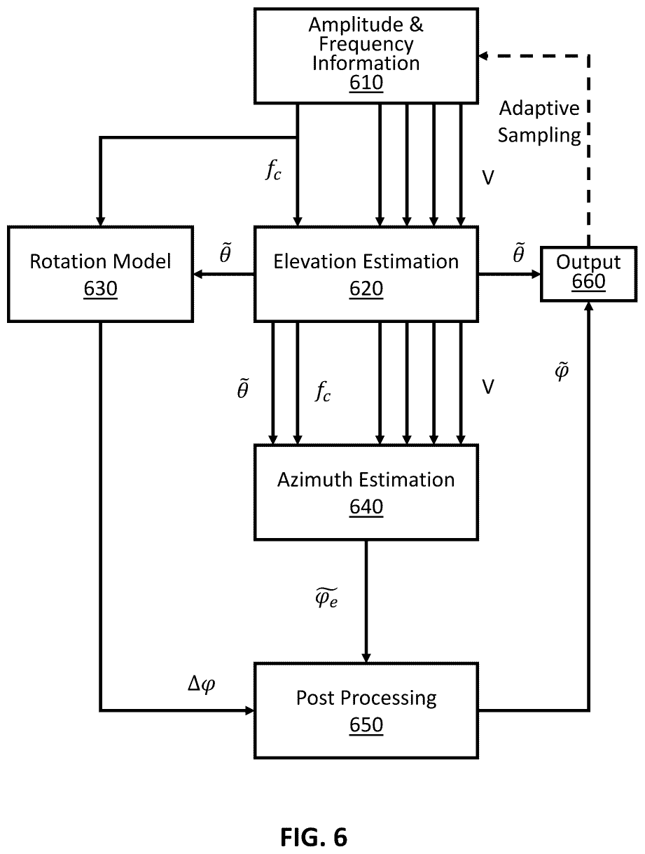

FIG. 6 illustrates a block flow diagram for the direction finding system 100 of FIG. 1 to perform direction finding according to various aspects of the present disclosure. When measurement data from four spiral arms of the multi-arm spiral antenna 110 is collected, the computing device 160 may perform Fourier transformation on the measurement data, which comprises amplitude information only from the four spiral arms of the multi-arm spiral antenna 110. Based on the Fourier transformation, the frequency f_{c} of the measurement data may be identified at block 610.

The identified frequency f_{c} and the four channel voltage amplitude measurement data are fed to block 620, and used for the AI algorithm to predict an elevation angle. Prediction of the elevation angle may have to occur first, as it influences performance of the azimuth estimation. The AI algorithm may employ neural network (NN) approaches. Since there are infinite possibilities of combinations among the number layers in the NN, the number neurons in each layer, activation functions, dataset size, and optimizer, any number of layers and any number of neurons in each layer may be chosen for prediction of the elevation angle based on the frequency fc and the four channel amplitude information. For example, a systematic, constrained, procedure, a network with 9 hidden layers is chosen. Each layer has a rectified linear activation function. The input layer has 5 inputs: the magnitudes from four channels and the frequency of operation. On the other hand, the output regression layer consists of a single neuron, that outputs the elevation angle θ.

A training dataset consisting of one million samples is generated with a uniform distribution of incident signals across a range of frequencies, 1.5 GHZ-6 GHZ, full 360° of the azimuth angle φ, and 0-50° of the elevation angle θ. A dataset split ratio may be selected with 85% allocated to training, 10% allocated to validation, and 5% allocated to preliminary testing. Stochastic gradient descent may be used for optimization of the network weights, with a learning rate of 5e⁻⁵, attenuating by 1% every three epochs, for 500 epochs. These allocations and rates are provided as examples and not meant to limit the scope of the present disclosure thereto. In aspects, there are other combinations of the allocations and rates.

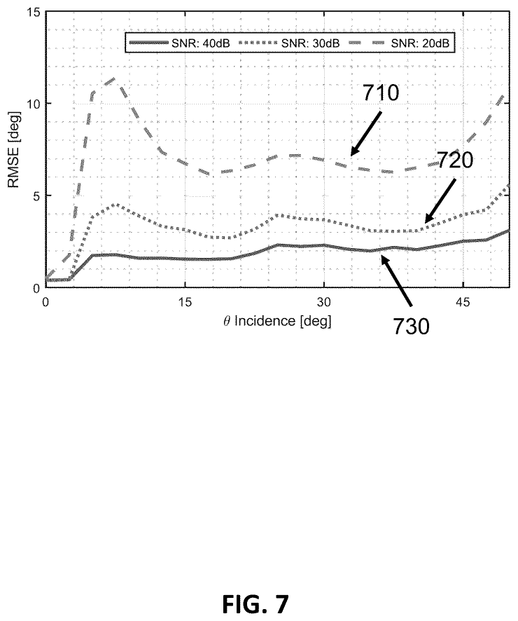

The performance of measurements is illustrated in curves 710-730 in FIG. 7. The horizontal axis represents the elevation angle θ, and the vertical axis represents root-mean-square-errors (RMSEs) in degrees. The curves 710-730 are based on 20 dB, 30 dB, and 40 dB of the signal-to-noise ratio (SNR), respectively. For example, at 40 dB SNR, the average RMSE is about 1.88°, meaning that the estimated or predicted elevation angle is 1.88° off from the actual elevation angle. The region defined by small θ angles may be a region with high RMSE at block 620. The elevation estimation error drives the overall single-angle error of the DF system at these elevation angles. Low errors are observed for low elevation angles θ at high SNR values. However, degradation is observed as the level of noise increases at higher elevation angles θ. Thus, at block 620, the AI algorithm may be able to predict or estimate an elevation angle \tilde{θ} based on the identified frequency f_{c} and the four channel voltage amplitude measurement data fed from block 610. The estimated elevation angle \tilde{θ} is provided to block 630.

Now returning back to FIG. 6, the identified frequency f_{c} may be also fed to block 630 from block 610, in which a rotation model may output a rotation or azimuthal offset Δφ based on the frequency f_{c} and the estimated elevation angle \tilde{θ}. The azimuth estimation may stem from the capacity to model the radiation patterns as a function of frequency. A method for fixing the radiation patterns leverages the primary assumption of the multi-arm spiral antenna that radiation patterns may be approximately equal to radiation patterns at a particular base frequency with an azimuthal offset Δφ, which is a function of the frequency f_{c} and the estimated elevation angle \tilde{θ}.

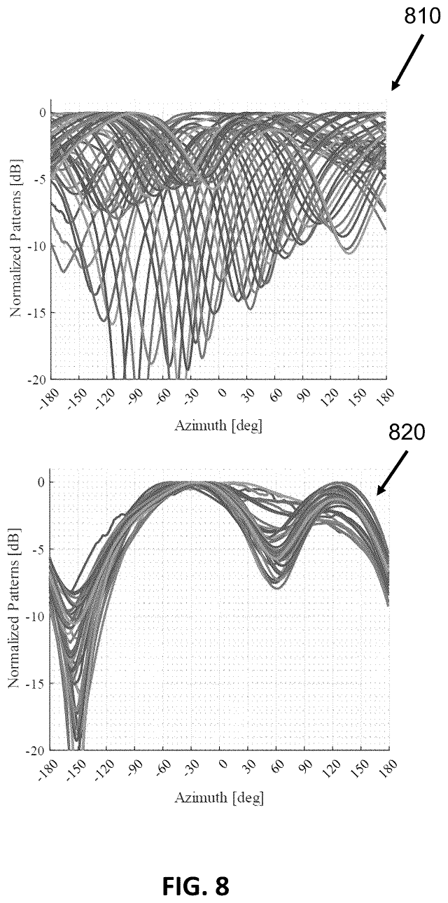

FIG. 8 illustrates curves 810 and 820 of radiation patterns before and after fixing a signal rotation or the estimated elevation angle \tilde{θ} in accordance with various aspects of the present disclosure. Curves 810 show radiation patterns at the 30° elevation angle conical cut before fixing the estimated elevation angle \tilde{θ}, and curves 820 radiation patterns at 30° elevation angle conical cut after fixing the estimated elevation angle \tilde{θ}.

Fixing the estimated elevation angle \tilde{θ} may be performed first by fixing the radiation patterns at the lowest frequency of operation to a particular azimuth angle as a reference. Patterns at the next frequency may be compared with the patterns at the present frequency and rotated until the error between the patterns are minimized. The value of this rotation offset is recorded as the azimuthal offset Δφ. This process may be repeated for every consecutive pair of frequencies that are considered, and for each elevation angle. This may ensure that all the patterns are stable and pointed to an approximately fixed location. The azimuthal angular offset Δφ required to fix the signal rotation may be recorded for every frequency and elevation angle to form the angular offset model or the rotation model at block 630.

An example of signal-fixing is illustrated in FIG. 8 using measured radiation patterns. This frequency model does not impact the elevation estimation, nor does it impact the subregion classification. This angular value is used to offset the azimuth value fed to the subregion estimation training process, to make the subregion estimation network think it is learning stable patterns. The rest of the DF system infrastructure (frequency, elevation, and subregion number) may be used to interpret the results of the subregion estimator with respect to the global coordinate system. This aspect of the DF system 100 may reduce system complexity. In this case, the slower the patterns rotate in frequency, the more broadband is any particular offset solution. This may provide robustness to frequency identification errors or allow for simplification in the configuration of the DF system 100. The corresponding antenna parameter may be determined by inspection: for a fixed aperture size and thus bandwidth, reducing the number of turns of each spiral arm may reduce the pattern rotation speed as a function of frequency.

Before the azimuthal angular offset Δφ is applied, the normalized patterns of the signal spread across the 360° azimuth angle range as shown in the curves 810. On the other hand, after the azimuthal angular offset Δφ is applied, the normalized patterns of the signal show similar patterns across the 360° azimuth angle range as shown in the curves 820.

Now returning back to FIG. 6, the identified frequency f_{c}, the estimated elevation angle \tilde{θ}, and the four channel voltage amplitude measurement data are fed to block 640, and used for the AI algorithm to estimate an azimuth angle [symbol] . In particular, the full 360° azimuth field of view (FOV) is broken up into four subregions. Firstly, a classifier network may be developed to determine which subregion the signal falls into. Secondly, the subregion estimator may be applied to the rotated reference frame declared by the subregion classifier. This may allow for a single, simpler network to perform estimation that covers the entire azimuthal FOV.

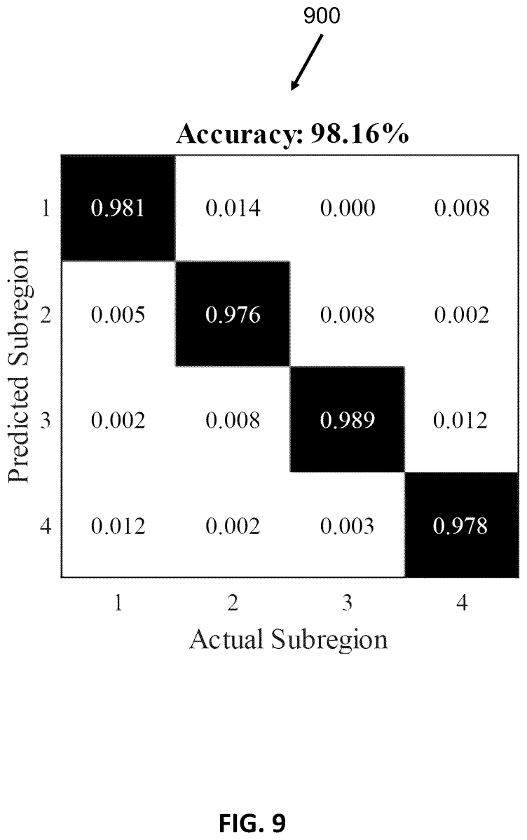

The measured classifier performance is illustrated as a confusion matrix in FIG. 9. The confusion matrix 900 shows how many predictions are correct and incorrect per subregion. It helps in understanding the subregions that are being confused as other subregions. The horizontal axis represents actual subregions and the vertical axis represents predicted subregions. As illustrated, prediction of the first subregion is 98.1% for the first actual subregion, and predictions of the other subregions are 1.9% for the first actual subregion. The average accuracy for correctly predicting subregions is 98.16%. In other words, the probability of predictions of incorrect subregions is comparatively low.

The AI algorithm may utilize 9 hidden layers, each with a width of 128 and rectified linear unit (ReLU) activation functions. The number of hidden layers and the width are not limited thereto but may be any number under the circumstances. A softmax output layer may be included in the neural network of the AI algorithm just prior to the output layer. The same network architecture may be used for the subregion estimation. With an output layer width of two and without the softmax function, two outputs of the output layer may be sine and cosine of the estimated azimuth angle [symbol] .

The subregion estimator of the AI algorithm may operate on a restricted global field of view (FOV), and the AI algorithm may be trained to locate signals over a 90° span starting from some reference angle φ₀ (and, due to rotational symmetry φ₀+90°, φ₀+180°, and φ₀+270°. The subregion classifier may dictate what integer multiple of 90° offset is used from that reference angle φ₀ when the angle of arrival is determined.

The added layer of complexity in the azimuth estimation with the spiral arms of the multi-arm spiral antenna may be this frequency modeling. Depending on the growth rate of the spiral arm and the number of turns of the spiral arm, the radiation patterns may rotate more quickly or slowly as a function of frequency. The outputs of the azimuth estimation may be the sine and cosine of the estimated azimuth angle [symbol] , rather than the estimated azimuth angle [symbol] itself.

Regardless of the 90° FOV restriction of the subregion, once the frequency modeling is applied, the angular span the subregion estimator covers (when the antenna covers sufficient bandwidth, with a sufficient number of turns) is 360°. In an aspect, the number of spiral arms of the multi-arm spiral antenna 110 may determine the angular FOV restriction of the subregion. For example, when the number of spiral arms is three, the angular FOV restriction of the subregion is 120°, and when the number of arms is six, the angular FOV restriction of the subregion is 60°. Based on the number of spiral arms of the multi-arm spiral antenna 110 and the angular FOV restriction of the subregion, the whole FOV may cover 360°.

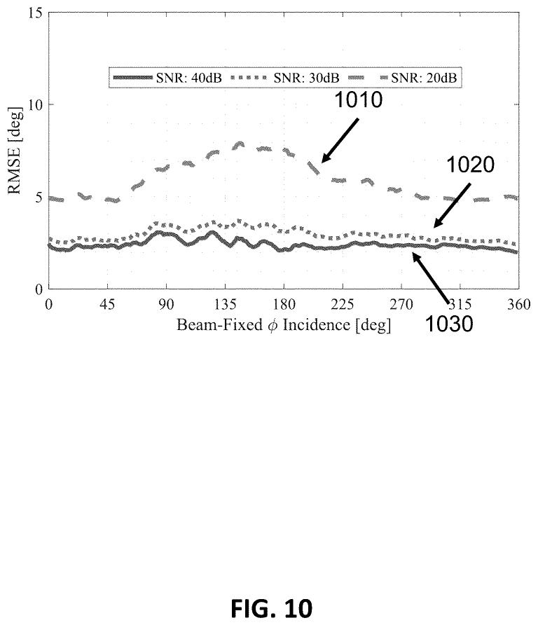

FIG. 10 illustrates classifier performance for the azimuthal subregion estimations at various SNRs. The horizontal axis represents azimuth angles φ ranging from 0° to 360° and the vertical axis represents RMSE in degrees. Curves 1010-1030 show azimuthal subregion estimations using measured data at SNR levels of 20 dB, 30 dB, and 40 dB, respectively. With 40 dB SNR, the average RMSE is 2.38° across the entire azimuthal FOV, and the average RMSEs are 2.94° and 5.89° at 30 dB and 20 dB SNR, respectively.

Now returning back to FIG. 6, at block 640, the estimated azimuth angle [symbol] is outputted to block 650. Based on the azimuth offset Δφ calculated at block 630, the estimated azimuth angle [symbol] outputted from block 640 may be adjusted at block 650 and the adjusted azimuth angle \tilde{φ} is outputted from block 650.

It is noted that the adjusted azimuth angle \tilde{φ} is an angle between the north direction and the source of the signal with respect to the location of the DF system, and that the elevation angle \tilde{θ} is an angle between the height direction or Z-axis direction and the source of the signal with respect to the DF system. Thus, with the estimated elevation angle \tilde{θ} and the adjusted azimuth angle \tilde{φ}, the direction of the transmission source of the signal from the DF system may be identified at block 660.

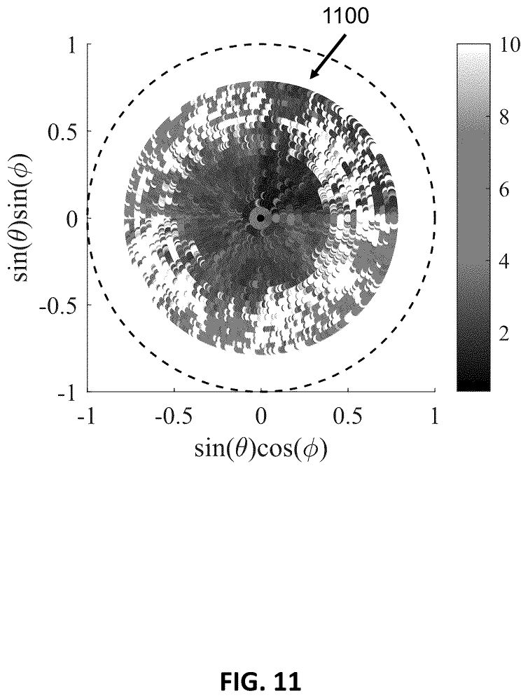

In a case where the outputs of the azimuth estimation are sine and cosine of the estimated azimuth angle [symbol] , a UV space may be used as illustrated in FIG. 11. The horizontal axis is U representing sin(θ)cos(φ), and the vertical axis is V representing sin(θ)sin(φ). Based on measurement data, each point in graphical representation 1100 is expressed in RMSE or a shade density. The graphical representation 1100 is illustrated in a circle based on the measurement data through all elevation angle θ and all azimuth angle φ. In other words, when an estimated elevation angle \tilde{θ} and adjusted azimuth angle \tilde{φ} are determined based on measurement data at each elevation angle θ and each azimuth angle φ, the single error may be computed by the following equation:

$${Error}_{single - angle} = {cos}^{- 1} ( \frac{Ψ \cdot \tilde{Ψ}}{\vert Ψ \vert \cdot \vert {Ψ}^{\approx } \vert} ) , \qquad ( 6 )$$

where Ψ is a cartesian representation of the actual angle of arrival of the signal and \tilde{Ψ} is the cartesian representation of the estimated angle of arrival by the DF system. Based on equation (6), at each angle of arrival or at each elevation angle and each azimuth angle, RSMEs of the single errors are computed and represented in the graphical representation 1100 with a corresponding shade density. The average RSME is about 5.4° across the entire FOV and two-octave bandwidth (e.g., 1.5 GHz to 6 GHz).

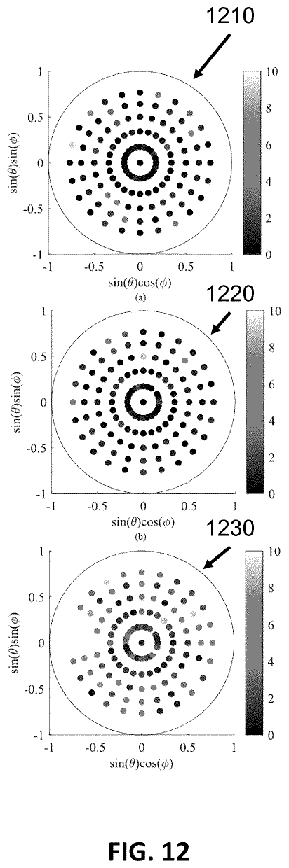

FIG. 12 illustrates another graphical representations 1210-1230 of RMSEs of experiment data in the UV-space in accordance with various aspects of the present disclosure. Compared to FIG. 12, RSMEs are computed every 10° in elevation angles and every 15° in azimuth angles using equation (5). Thus, each graphical representations 1310-1330 has six circles, meaning that 60° elevation angles (6*10°=60° are covered, and each circle in the graphical representations 1310-1330 has 24 points, meaning that 360°) (24*15°=360° azimuth angels are covered. RSMEs shown in the graphical representations 1210-1230 are computed at frequencies of 1.5 GHZ, 3 GHZ, and 6 GHz, respectively. The average RSME across the entire FOV and bandwidth is about 2.4°.

Now returning back to FIG. 6, in an aspect, based on the estimated elevation angle \tilde{θ} and the adjusted azimuth angle @, an adaptive sampling may be performed on the signal between blocks 660 and 610. The adaptive sampling may increase the number of samples in a way such that, for a given error bound, the signal averaging will boost the effective SNR to the point with which the DF system may be able to estimate the angle-of-arrival or the direction to the transmission source of the signal within the error.

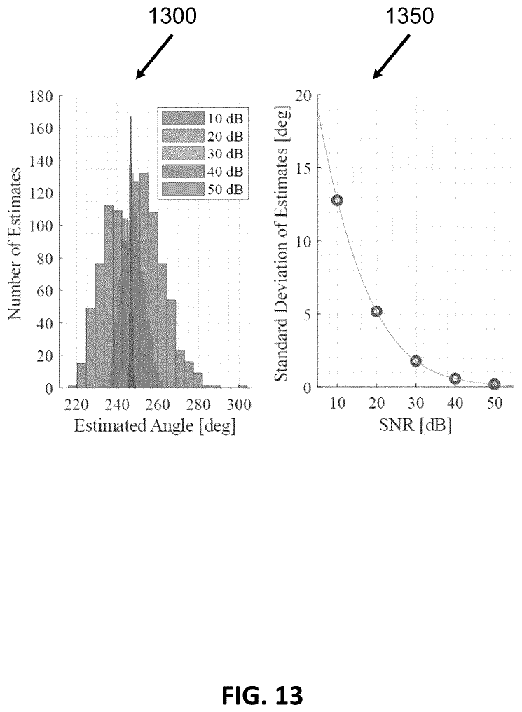

For example, FIG. 13 illustrates output distributions 1300 of the estimated angles in a histogram and the corresponding standard deviation curve 1350 of the signal in accordance with various aspects of the present disclosure. The horizontal axis represents the estimated angles in degrees from 210° to 310°, and the vertical axis represents the number of estimates. The output distributions 1300 shows that the estimated angles are generally distributed across the angle range from 220° to about 290° at 10 dB SNR, while the estimated angles are distributed in a short angle range from 230° to about 260° at 20 dB SNR and the estimated angles are distributed at about 250° at 50 dB SNR.

A standard deviation may be plotted along various SNRs according to curve 1350. The horizontal axis represents the SNR in dB, and the vertical axis represents standard deviation of estimates in degrees. A polynomial approximation may be generated based on the output distribution curve 1300. For example, the polynomial approximation equation for the curve 1350 is 2.823*10⁻⁶*X⁴−0.0006209*X³+0.05126*X²−1.906*X+27.3.

For example, when the standard deviation of the measurement data is about 2°, 30 dB SNR is to be selected according to the curve 1350, and the corresponding snapshots (e.g., the estimated angles from about 240° to about 260°) are correspondingly selected for adoptive sampling. Further, to obtain 30 dB SNR, for standard deviation being less than 1.75°, no additional sampling is required. In a case where the standard deviation is greater than 1.75 but less than 5.25°, snapshots are needed to achieve 30 dB SNR. Similarly, a standard deviation greater than 5.25 and less than 12.75° may require 100 snapshots.

In this way, the outputs, the estimated elevation angle \tilde{θ} and the adjusted azimuth angle \tilde{φ}, may be used for adoptive sampling so that more related output distributions may be sampled. Thereby, the direction finding may be performed in a focused manner with increased accuracy.

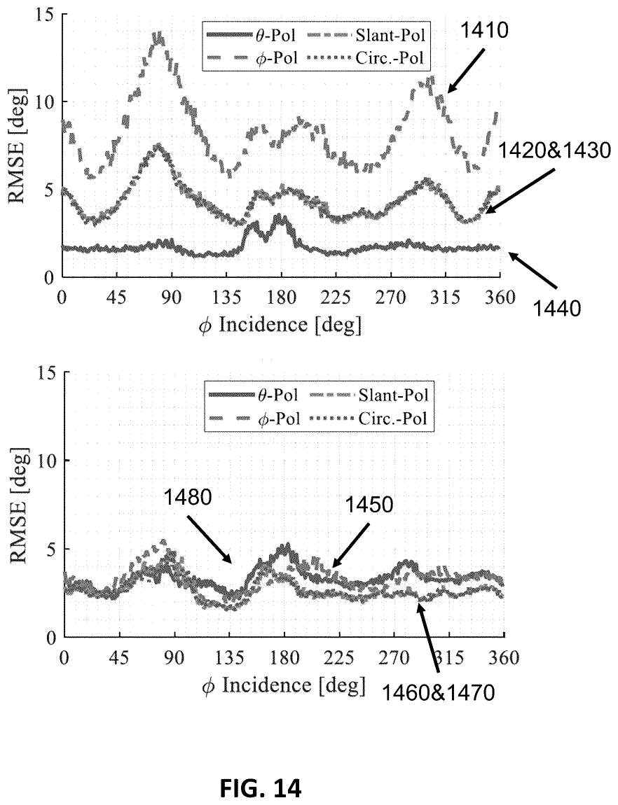

The signals are generally electromagnetic wave, in which the electric field oscillates on the horizontal plane or vertical plane, with each other and such are called θ-polarized or φ-polarized signal, respectively. In some instances, the electric wave oscillates with a 45° angle or any other angle with the vertical or horizontal plane and such is called slant-polarized signal. In another instance, the electric field rotates with respect to the horizontal or vertical plane and such is called circular-polarized signal. The DF system as disclosed in the present application may be able to handle signals with varying polarizations. The AI algorithm may be further trained based on the impact of various polarizations in the signal. RMSEs are illustrated in curves 1410-1480 of FIG. 14. Specifically, curves 1410-1440 show RMSEs across the whole azimuth range from 0° to 360° with the AI algorithm, which has been trained with θ-polarized signals, and curves 1410-1440 show RMSEs across the whole azimuth range from 0° to 360° with the AI algorithm, which has been trained with all kinds of polarized signals. As expected and based on the curves 1410-1480, the AI algorithm trained only with θ-polarized signals shows higher RMSEs than the AI algorithm trained with all types of polarizations.

The initial error in the φ-polarized signal is due to the differences in the radiation patterns with respect to θ- vs. φ-polarizations of the multi-arm spiral antenna. If these polarizations exhibited the same radiation characteristics (i.e., θ-pol patterns are identical to φ-pol patterns), the responses would be identical, and the DF system may respond identically to all polarizations. These results demonstrate that, in a case where the θ- and φ-polarized radiation patterns cannot be unified, the AI algorithm needs to be trained to be more robust to different polarizations. Curves 1450-1480 show that training the network on various polarization signals can streamline the error responses with respect to each polarization. In a case where a higher overall error is acceptable, the performance of the AI algorithm may be substantially polarization-agnostic.

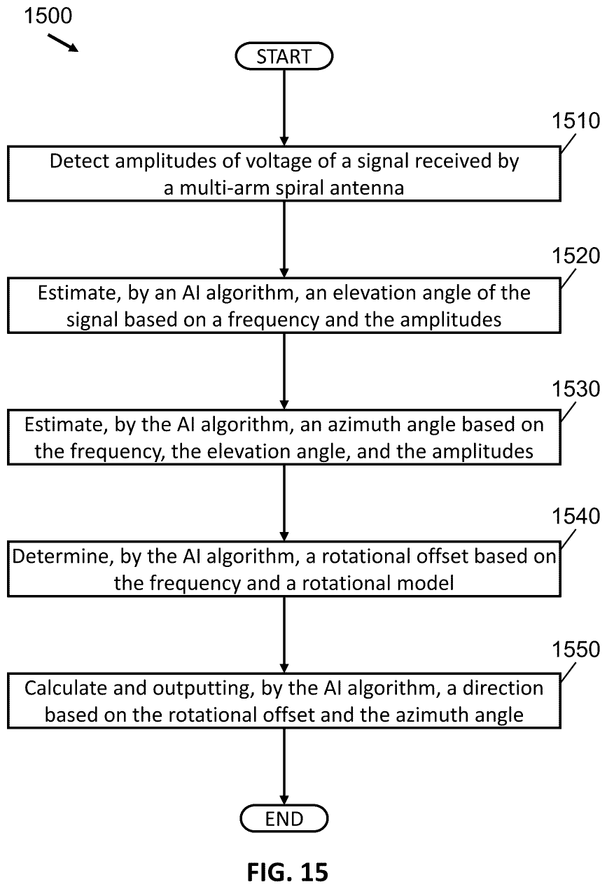

FIG. 15 illustrates a flowchart for a method 1500 for performing direction finding in accordance with various aspects of the present disclosure. The method 1500 may be performed by a direction finding system (e.g., the direction finding system 100 of FIG. 1), which includes a multi-arm spiral antenna configured to receive a signal. The multi-arm spiral antenna may have four spiral arms and each spiral arm may detect the signal. In an aspect, the number of spiral arms of the multi-arm spiral antenna may be two, three, four, or more than four. Without losing generality and for brevity of description, four spiral arms are used below. Detection results may be amplitudes of voltage of the signal.

The method 1500 may include step 1510, which is performed by detecting the signal by the multi-arm spiral antenna. The signal is an analog signal including amplitudes of voltage along a period of time. The detection results, on the other hand, may be digitized and have four channel voltage amplitude measurement data.

The method 1500 may further include step 1520, at which estimating, by an AI algorithm, an elevation angle of the signal based on a frequency and the amplitudes is performed. The AI algorithm may have been trained with a set of training data. Further, the AI algorithm may be a neural network (NN), which includes a number of hidden layers and one output layer. The number of hidden layers may be three, four, or more than four. In an aspect, the number of hidden layers may be nine. In another aspect, the neural network may further include a softmax output layer disposed between the hidden layers and the output layer. Each hidden layer of the NN may have a width of 128 and rectified linear unit (ReLU) activation functions.

At step 1520, Fourier transformation may be applied to the four channel amplitude data to obtain the frequency of the signal. The frequency may be a wideband frequency with multiple octaves. For example, the range of frequency with two octaves may be from 1.5 GHz to 6 GHz. In an aspect, the frequency may be from 0.2 GHz to 8 GHZ.

Further, at step 1520, based on the four channel amplitude measurement data, the AI algorithm may be capable of estimating the elevation angle of the signal. The elevation angle is an angle between the source of the signal and the multi-arm spiral antenna with respect to the height direction. Thus, the elevation angle may range from −90° to 90° or from 0° to 180°.

The method 1500 may further include step 1530, at which estimating, by the AI algorithm, an azimuth angle based on the frequency, the elevation angle, and the amplitudes is performed. The azimuth angle is an angle between the north direction and the source of the signal with respect to the multi-arm spiral antenna. Thus, the azimuth angle ranges from 0° to 360°.

The method 1500 may further include step 1540, at which determining, by the AI algorithm, a rotational offset based on the frequency and a rotational model is performed. The rotational offset may be a function of frequency and a rotational model, in which radiation patterns of the signal is fixed at the lowest frequency of operation to a particular azimuth angle as a reference. Based on the rotational model, the radiation patterns at the next frequency may be compared with the patterns at the present frequency and rotated until the error between the radiation patterns are minimized. This process may be repeated for every consecutive pair of frequencies that are considered. Hence, the rotational offset is a function of the frequency. The azimuthal angular offset required to fix the signal may be the angular offset.

The method 1500 may further include step 1550, at which calculating and outputting, by the AI algorithm, a direction of a source of the signal based on the rotational offset and the azimuth angle is performed. At step 1550, the estimated azimuth angle is adjusted based on the angular offset to estimate the actual azimuth angle of the source of the signal. The direction of the source of the signal is a combination of the azimuth angle and the elevation angle.

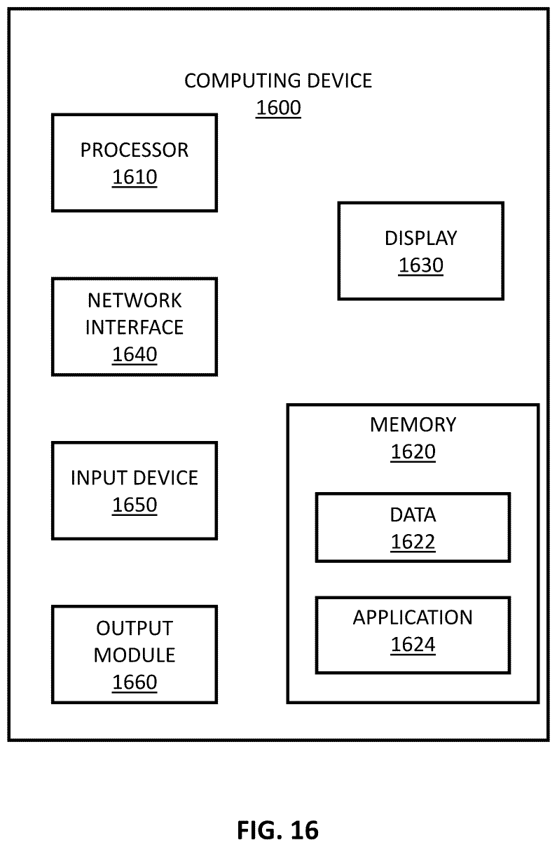

Turning now to FIG. 16, a simplified block diagram is provided for a computing device 1600, which can be implemented as the computing device 160 of FIG. 1. The computing device 1600 may be a laptop or desktop computer, server, edge computer, or cloud computer. The computing device 1600 may include a processor 1610, a memory 1620, a display 1630, a network interface 1640, an input device 1650, and/or an output module 1660. The memory 1620 includes any non-transitory computer-readable storage media for storing data and/or software that is executable by the processor 1610 and which controls the operation of the computing device 1600.

The computing device 1600 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 1610 may be a general purpose processor, a specialized graphics processing unit (GPU) configured to perform specific graphics processing tasks (e.g., parallel processing for training and testing data packets for potential cyberattacks) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 1620 may include one or more solid-state storage devices such as flash memory chips. Alternatively or in addition to the one or more solid-state storage devices, the memory 1620 may include one or more mass storage devices connected to the processor 1610 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 1610. That is, computer readable storage media may include non-transitory, volatile and non-volatile, removable and non-removable media implemented in any method or technology for storage of information such as computer-readable instructions, data structures, program modules or other data. For example, computer-readable storage media includes random access memory (RAM), read-only memory (ROM), erasable programmable read-only memory (EPROM), electrically erasable programmable read-only memory (EEPROM), flash memory or other solid state memory technology, compact disc read-only memory (CD-ROM), digital video disc (DVD), Blu-Ray or other optical storage, magnetic cassettes, magnetic tape, magnetic disk storage or other magnetic storage devices, or any other medium which can be used to store the desired information and which can be accessed by the computing device 1600.

The memory 1620 may store application 1624 (e.g., fingerprint database, AI algorithm, etc.) and/or data 1622 (e.g., fingerprints). The application 1624 may, when executed by processor 1610, cause the display 1630 to present the user interface to provide information to users. The application 1624 may be one or more software programs stored in the memory 1620 and executed by the processor 1610 of the computing device 1600. The application 1624 may be installed directly on the computing device 1600 or via the network interface 1640. The application 1624 may run natively on the computing device 1600, as a web-based application, or any other format known to those skilled in the art.

In an aspect, the application 1624 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PLI, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 1630 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 1630 is a plasma display, and a video projector. In various aspects, the display 1630 may be interactive (e.g., having a touch screen or a sensor such as a camera, a 3D sensor, etc.) that can detect user interactions/gestures/responses and the like so as to serve as both an input and output device.

The network interface 1640 may be configured to connect to a network such as a local area network (LAN) consisting of a wired network and/or a wireless network, a wide area network (WAN), a wireless mobile network, a Bluetooth network, and/or the internet.

For example, the computing device 1600 may process digital measurement data obtained from the multi-arm spiral antenna, through the network interface 1640, to identify a direction of the transmission source of the signal. The computing device 1600 may update the AI algorithm, for example, the application 1624, via the network interface 1640. The computing device 1600 may also display processed results and any notification from training and/or testing on the display 1630.

The input device 1650 may be any device by means of which a user may interact with the computing device 1600, such as, for example, a mouse, keyboard, touch screen, and/or any other interface. The output module 1660 may include any connectivity port or bus, such as, for example, parallel ports, serial ports, universal serial busses (USB), or any other similar connectivity port known to those skilled in the art.

The aspects disclosed herein are examples of the disclosure and may be embodied in various forms. Although certain aspects herein are described as separate aspects, each of the aspects herein may be combined with one or more of the other aspects herein. It should also be understood that, depending on the example, certain acts or events of any of the processes or methods described herein may be performed in a different sequence, may be added, merged, or left out altogether (e.g., all described acts or events may not be necessary to carry out the techniques). In addition, Specific structural and functional details disclosed herein are not to be interpreted as limiting, but as a basis for the claims and as a representative basis for teaching one skilled in the art to variously employ the present disclosure in virtually any appropriately detailed structure.

In various aspects, the techniques described herein relate to a non-transitory computer readable medium including computer executable instructions that, when executed by a computer, cause the computer to perform a method for detecting cyberattacks in network communication.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A direction finding system comprising:
a multi-arm spiral antenna configured to receive a signal;
a processor; and
a memory including instructions that, when executed by the processor, cause an artificial algorithm (AI) to:
detect amplitudes of voltage of the signal received by the multi-arm spiral antenna;
estimate, by an artificial intelligence (AI) algorithm, an elevation angle of the signal based on a frequency and the amplitudes of voltages of the signal;
estimate, by the AI algorithm, an azimuth angle based on the frequency, the elevation angle, and the amplitudes;
determine, by the AI algorithm, a rotational offset based on the frequency and a rotational model; and
calculate and output, by the AI algorithm, a direction of a source of the signal based on the rotational offset and the azimuth angle.

2. The direction finding system according to claim 1, further comprising:
a coaxial cable bundle coupled to the multi-arm spiral antenna.

3. The direction finding system according to claim 2, wherein each coaxial cable is coupled to a respective arm of the multi-arm spiral antenna.

4. The direction finding system according to claim 1, wherein a number of arms in the multi-arm spiral antenna is greater than or equal to two.

5. The direction finding system according to claim 1, wherein each arm of the multi-arm spiral antenna is Archimedean or log-periodic spiral antenna.

6. The direction finding system according to claim 1, wherein a first portion of training data is for training the AI, a second portion of the training data is for validation, and a third portion of the training data is used for optimization of weights used in the AI.

7. The direction finding system according to claim 6, wherein a rotational offset in the rotational model has been determined based on actual angles of arrival of the training data and predicted angles of arrival.

8. The direction finding system according to claim 1, wherein a frequency range of the signal is from 1.5 GHz to 6 GHz.

9. The direction finding system according to claim 1, wherein the direction indicates a direction from which the signal is transmitted.

10. The direction finding system according to claim 1, wherein the direction finding system does requires use of neither mode forming circuitry, nor beam forming circuitry, nor phase compensation circuitry.

11. A method for performing direction finding with a direction finding system including a multi-arm spiral antenna configured to receive a signal, the method comprising:
detecting amplitudes of voltage of the signal received by the multi-arm spiral antenna;
estimating, by an artificial intelligence (AI) algorithm, an elevation angle of the signal based on a frequency and the amplitudes of voltages of the signal;
estimating, by the AI algorithm, an azimuth angle based on the frequency, the elevation angle, and the amplitudes;
determining, by the AI algorithm, a rotational offset based on the frequency and a rotational model; and
calculating and outputting, by the AI algorithm, a direction of a source of the signal based on the rotational offset and the azimuth angle.

12. The method according to claim 11, wherein the direction finding system includes a coaxial cable bundle coupled to the multi-arm spiral antenna.

13. The method according to claim 12, wherein each coaxial cable is coupled to a respective arm of the multi-arm spiral antenna.

14. The method according to claim 11, wherein a number of arms in the multi-arm spiral antenna is greater than or equal to two.

15. The method according to claim 11, wherein each arm of the multi-arm spiral antenna is an Archimedean or log-periodic spiral antenna.

16. The method according to claim 11, wherein a first portion of training data is for training the AI, a second portion of the training data is for validation, and a third portion of the training data is used for optimization of weights used in the AI.

17. The method according to claim 16, wherein a rotational offset in the rotational model has been determined based on actual angles of arrival of the training data and predicted angles of arrival.

18. The method according to claim 11, wherein a frequency range of the signal is from 1.5 GHz to 6 GHz.

19. The method according to claim 11, wherein the direction indicates a direction from which the signal is transmitted.

20. A non-transitory computer readable medium including instructions that, when executed by a computer, cause an artificial algorithm (AI) to perform a method for performing direction finding with a direction finding system including a multi-arm spiral antenna configured to receive a signal, the method comprising:
detecting amplitudes of voltage of the signal received by the multi-arm spiral antenna;
estimating, by an artificial intelligence (AI) algorithm, an elevation angle of the signal based on a frequency and the amplitudes of voltages of the signal;
estimating, by the AI algorithm, an azimuth angle based on the frequency, the elevation angle, and the amplitudes;
determining, by the AI algorithm, a rotational offset based on the frequency and a rotational model; and
calculating and outputting, by the AI algorithm, a direction of a source of the signal based on the rotational offset and the azimuth angle.
